(19) United States
(12) Patent Application Publication
(10) Pub. No.: US 2008/0216958 A1
(43) Pub. Date: Sep. 11, 2008

(54) Plasma Reaction Apparatus Having Pre-Seasoned Showerheads and Methods for Manufacturing the Same

(75) Inventors: Haruhiro Harry GOTO, Saratoga, CA (US); James A. FAIR, Mountain View, CA (US); David CHEUNG, Foster City, CA (US)

Correspondence Address: INGRASSIA FISHER & LORENZ, P.C., 7010 E. COCHISE ROAD, SCOTTSDALE, AZ, 85253, US

(73) Assignee: NOVELLUS SYSTEMS, INC., San Jose, CA (US)

(21) Appl. No.: 11/683,124

(22) Filed: Mar. 7, 2007

(51) Int. Cl. C23F 1/00; B05D 1/00; H01S 4/00

(52) U.S. Cl. 156/345.35; 29/592.1; 427/401

(57) ABSTRACT

Plasma reaction apparatus having pre-seasoned showerheads and methods for pre-seasoning a showerhead of a plasma reaction apparatus are provided. In an embodiment, a method for seasoning a showerhead prior to installation in a plasma reaction apparatus comprises cleaning the showerhead, positioning the showerhead in a deposition chamber, and forming a continuous, substantially uniform protective layer on the showerhead.

### FIELD OF THE INVENTION

The present technology relates generally to apparatus used in the fabrication of semiconductor devices, and more particularly, the present technology relates to plasma reaction apparatus having pre-seasoned showerheads and methods for manufacturing the same.

### BACKGROUND OF THE INVENTION

In semiconductor manufacturing, plasma ashing is the process of removing a photoresist from an etched semiconductor wafer. Plasma in this context is a gaseous mixture of ionized and excited state neutral atoms and molecules. A plasma producing apparatus, also referred to as a plasma reaction apparatus, produces a monatomic reactive species of oxygen or another gas required for the ashing process. Oxygen in its monatomic or single atom form, as O* free radicals rather than O₂, is the most common reactive species, although excited state and ionized forms of O₂ and O₃ also would be present in the plasma. The reactive species combines with the photoresist to form volatile oxides of carbon (e.g. CO, CO₂) and water, which are removed from the work piece with a vacuum pump. When used for photoresist removal, the plasma reaction apparatus often is referred to as an ashing apparatus.

The plasma reaction apparatus can be either a remote (down-stream) or an in-situ plasma reaction apparatus. FIG. 1 is a simplified cross-sectional illustration of a conventional apparatus 100 used for remote plasma exposure. In apparatus 100, a plasma 104 is created by direct excitation of molecular gas, indicated by arrows 102, flowing through a plasma generation container 106, typically a quartz tube, with an inductive coil 108 encircling it. RF power is applied to the coil 108 creating atomic, ionized, and excited state gas species or plasma. The plasma production is confined to the quartz tube. A substrate 112, such as a semiconductor substrate, upon which is disposed a photoresist is positioned in a processing chamber 114 downstream from the center of the coil 108 such that the substrate 112 is not exposed directly to the plasma. The processing chamber 114 may be separated from the quartz tube by a gas distribution plate 116, otherwise known as a showerhead, which is configured to distribute the plasma evenly over substrate 112. The processing chamber 114 includes a substrate support pedestal 120 that includes a heater (not shown) and low pressure is maintained within the processing chamber by a vacuum pump via conduit 118.

The showerhead 116, a conventional embodiment of which is illustrated in FIG. 2, typically is made from aluminum or ceramic, although other materials also have been used. As the power level and current through the coil 108 are increased, significant voltages exist on the coil. The high voltages generate a high electric field across the quartz and can cause significant ion bombardment and sputtering on the inside of the quartz tube, releasing silicon oxide (SiₓO_{y}). As the silicon oxide is sputtered from the quartz tube walls, it travels to the showerhead (carried by gravity and gas flow) and over time forms a silicon oxide coating on an underside surface 130 surface of the showerhead. As oxygen radicals pass through a new showerhead and into the processing chamber 114, the underside surface 130 of the showerhead that first contacts the plasma becomes a surface for recombination of the oxygen radicals. Recombination of the oxygen radicals on the showerhead results in an initial low ashing rate of the photoresist until the showerhead becomes “seasoned” or “conditioned”, that is, until a sufficient amount of silicon oxide has deposited and/or aluminum oxide has formed on the showerhead so that the recombination rate is reduced to that expected for a silicon oxide surface. Thus, as the showerhead becomes seasoned, the ashing rate increases. Once the showerhead is sufficiently seasoned, the ashing rate becomes substantially uniform.

To make the ashing rate uniform when a new showerhead is installed in the plasma reaction apparatus, efforts to season the showerhead in situ have been made. These efforts include subjecting the new showerhead to the plasma process, with or without semiconductor wafers in the processing chamber, until the showerhead is seasoned. This seasoning or conditioning process typically requires 10 to 25 hours or more of plasma generation in the plasma reaction apparatus. If semiconductor wafers are not in the processing chamber during seasoning, this seasoning process results in downtime of the apparatus. If semiconductor wafers are in the chamber during seasoning, the wafers may experience low ash rate and poor ash uniformity wherein the photoresists of the wafers may not be ashed sufficiently or uniformly and may have to be subjected to the plasma for a longer period of time to be removed.

Accordingly, it is desirable to provide methods for pre-seasoning showerheads before installation in plasma reaction apparatus. In addition, it is desirable to provide methods for fabricating plasma reaction apparatus with pre-seasoned showerheads. It also is desirable to provide plasma reaction apparatus with pre-seasoned showerheads. Furthermore, other desirable features and characteristics of the present invention will become apparent from the subsequent detailed description of the invention and the appended claims, taken in conjunction with the accompanying drawings and this background of the invention.

### BRIEF DESCRIPTION OF THE DRAWINGS

The present invention will hereinafter be described in conjunction with the following drawing figures, wherein like numerals denote like elements, and

FIG. 1 is a cross-sectional view of a conventional plasma reaction apparatus;

FIG. 2 is an isometric view of a showerhead of the plasma reaction apparatus of FIG. 1;

FIG. 3 is a method for fabricating a plasma reaction apparatus in accordance with an exemplary embodiment of the present invention;

FIG. 4 is a method for pre-seasoning a showerhead in accordance with an exemplary embodiment of the present invention; and

FIG. 5 is a cross-sectional view of a showerhead of a plasma reaction apparatus wherein the showerhead has a protective layer in accordance with an exemplary embodiment of the present invention.

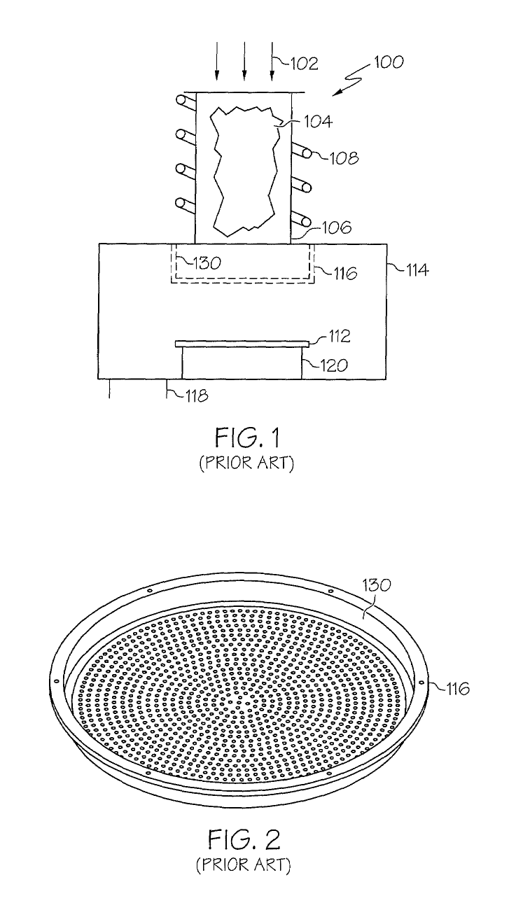

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

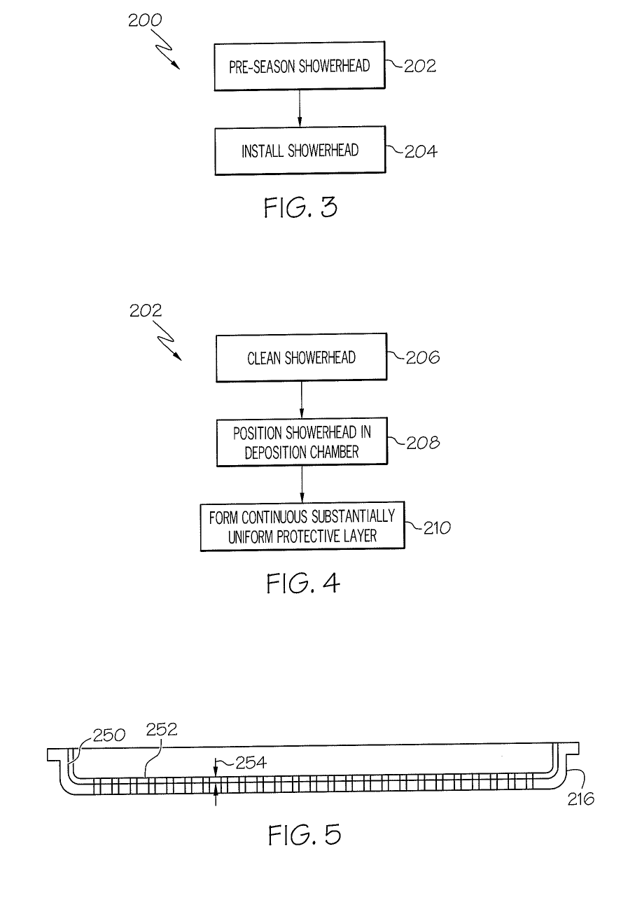

A method 200 for fabricating a plasma reaction apparatus, in accordance with an exemplary embodiment of the present invention, is illustrated in FIG. 3. The method comprises the step of pre-seasoning a gas distribution plate, referred to herein as a “showerhead” (step 202). As used herein, the term “pre-seasoning” means coating a surface of the showerhead with a continuous, substantially uniform protective layer before installation of the showerhead in a plasma reaction apparatus. The protective layer is a material layer formed on the underside surface(s) of the showerhead, that is, the surface(s) of the showerhead facing the plasma generation container (i.e. quartz tube) when installed in a plasma reaction apparatus. The protective layer is any material layer that, during ashing, minimizes or prevents the recombination of oxygen from the oxygen-based plasma onto the showerhead and minimizes or prevents the deposition of silicon oxide resulting from sputtering of the plasma generation container during plasma generation. Once the showerhead is pre-seasoned, it is installed in the plasma reaction apparatus (step 204). Accordingly, a new pre-seasoned showerhead may be installed into a new plasma reaction apparatus or can replace a used showerhead in a plasma reaction apparatus. In either case, use of a pre-seasoned showerhead in a plasma reaction apparatus results in an improved initial ashing rate that stays substantially uniform during the ashing process on multiple wafers, thus reducing incomplete ashing of the photoresist.

A more detailed description of the method (step 202) for pre-seasoning a showerhead is illustrated in FIG. 4. The method (step 202) begins by cleaning the showerhead (step 206). Any suitable method for cleaning the showerhead of oils, greases and other organic and inorganic contamination may be used. In an exemplary embodiment of the invention, cleaning of the showerhead may comprise cleaning all surfaces of the showerhead with electronic grade isopropanol (IPA). If the showerhead is extremely oily or has many blind holes or areas, the showerhead also may be washed with a suitable cleaning compound, such as Labtone® cleaning compound available from VWR International, Inc. of Chester, Pa. The showerhead is rinsed in water and may be further cleaned in an acid bath such as, for example, a nitric acid bath containing 50% nitric acid and 50% water. Once suitably cleaned, the showerhead then may be rinsed and dried.

In accordance with an exemplary embodiment of the present invention, method 202 continues by positioning the showerhead in a deposition chamber (step 208) and forming a continuous, substantially uniform protective layer on the showerhead (step 210). The showerhead is positioned in any suitable deposition chamber such as, for example, the deposition chamber of a chemical vapor deposition (CVD) apparatus, a physical vapor deposition (PVD) apparatus, or a plasma-enhanced chemical vapor deposition (PECVD) apparatus. Referring momentarily to FIG. 5, a continuous, substantially uniform protective layer 252 is formed on an underside surface 250 of a showerhead 216. As used herein, the “underside surface 250” of showerhead 216 is the surface (or surfaces) of the showerhead that is facing or exposed to the plasma generation container when installed in an plasma reaction apparatus (i.e., ashing apparatus). As noted above, the protective layer 252 may comprise any material that, during ashing, minimizes or prevents the recombination of oxygen from the oxygen-based plasma onto the showerhead. Examples of materials suitable for forming protective layer 252 include silicon oxide (SiO₂), aluminum oxide (Al₂O₃), aluminum nitride (AlN), boron nitrate (BNO₃), aluminum fluoride (AlF), silicon nitride (Si₃N₄), titanium oxide (TiO), boron nitride (BN), boron oxide (B₂O₃), yttrium oxide (Y₂O₃), indium tin oxide (InSnO), and the like. In an exemplary embodiment of the invention, the protective layer 252 has a thickness, indicated by arrows 254, in the range of about 0.001 μm to about 50 μm. In a preferred embodiment of the invention, the protective layer 252 has a thickness 254 in the range of about 0.01 μm to about 5 μm. In a more preferred embodiment, the protective layer 252 has a thickness 254 of about 1 μm.

In one exemplary embodiment of the present invention, the showerhead is positioned in a PECVD apparatus on a CVD grounded electrode with its underside surface 250 facing up, that is, with its underside surface 259 facing up or exposed to the vapor source. The electrode is heated to a temperature in the range of about 200 to about 500° C., preferably about 400° C., and the showerhead temperature is allowed to stabilize. Tetraethyl orthosilicate (TEOS), and any suitable oxygen source such as, for example, nitrous oxide (N₂O), nitric oxide (NO), oxygen (O₂), and the like, then are introduced into the deposition chamber. For example, TEOS may be pumped into the chamber at a flow rate of about 150 to about 300 standard cubic centimeters per minute (sccm), preferably about 185 sccm, helium (He) may be pumped into the chamber at a flow rate of about 100 sccm, and nitric oxide may be pumped into the chamber at a flow rate of about 500 to about 4000 sccm, preferably about 3500 sccm. RF power of, for example, about 1150 W is applied to the PECVD apparatus for about 5 minutes to permit about 1 μm of SiO₂ to form on the showerhead.

In another exemplary embodiment, the protective layer 252 may be formed on the showerhead in a PVD apparatus. The showerhead is positioned on a PVD pedestal in the deposition chamber of the PVD apparatus with its underside facing up. The pedestal is heated to a temperature of about 50 to about 250° C., preferably about 100° C., and the showerhead temperature is allowed to stabilize. Argon is introduced into the deposition chamber. For example, argon may be pumped into the chamber at a flow rate of about 10 to about 50 sccm, preferably about 20 sccm. RF power is applied to the PVD apparatus for about 100 minutes to permit about 1 μm of SiₓO_{y} to be sputtered onto the showerhead from a silicon dioxide (SiO₂) source.

In yet another exemplary embodiment of the invention, the protective layer 252 may be formed on the showerhead in a CVD apparatus. The showerhead is positioned on a CVD grounded electrode with its underside surface 250 facing up. The electrode is heated to a temperature in the range of about 200 to about 600° C., preferably about 400° C., and the showerhead temperature is allowed to stabilize. Silane then is introduced into the deposition chamber at a pressure of about 1 to about 100 pounds per square inch absolute (psia) for about 5 minutes to permit about 3 to about 5 μm of silicon to form on the showerhead. The silicon layer then is oxidized by heating it to a temperature in the range of about 250 to about 450° C., preferably about 400° C. in an oxygen (O₂) environment for about 10 to about 15 hours to form a protective layer of SiO₂ on the showerhead. It will be appreciated that, while three embodiments for forming a silicon oxide protective layer on a showerhead have been provided, other methods for forming other protective layers on the showerhead may also be used.

Accordingly, methods for pre-seasoning a showerhead before installation into a plasma reaction apparatus (i.e., ashing apparatus) have been provided. Plasma reaction apparatus with pre-seasoned showerheads and methods for fabricating such plasma reaction apparatus also have been provided. Use of a pre-seasoned showerhead in a plasma reaction chamber results in an improved initial ashing rate that stays substantially uniform during the ashing process over multiple wafers, thus minimizing or preventing first wafer effects. While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for seasoning a showerhead prior to installation in a plasma reaction apparatus, the method comprising the steps of:
cleaning the showerhead;
positioning the showerhead in a deposition chamber; and
forming a continuous, substantially uniform protective layer on the showerhead.

2. The method of claim 1, wherein the step of forming a continuous, substantially uniform protective layer on the showerhead comprises the step of forming a layer of material on the showerhead wherein the material is selected from the group consisting of silicon oxide (SiO₂), aluminum oxide (Al₂O₃), aluminum nitride (AlN), boron nitrate (BNO₃), aluminum fluoride (AlF), silicon nitride (Si₃N₄), titanium oxide (TiO), boron nitride (BN), boron oxide (B₂O₃), yttrium oxide (Y₂O₃), indium tin oxide (InSnO).

3. The method of claim 1, wherein the step of forming a continuous, substantially uniform protective layer on the showerhead comprises the step of forming a protective layer having a thickness in the range of about 0.001 μm to about 50 μm.

4. The method of claim 3, wherein the step of the step of forming a protective layer having a thickness in the range of about 0.001 μm to about 50 μm comprises the step of forming a protective layer having a thickness in the range of about 0.01 μm to about 5 μm.

5. The method of claim 1, wherein the step of forming a continuous, substantially uniform protective layer on the showerhead comprises the steps of depositing a silicon layer on the showerhead and oxidizing the silicon layer.

6. The method of claim 5, wherein the step of oxidizing the silicon layer comprise the step of exposing the silicon layer to an oxygen-based plasma.

7. The method of claim 5, wherein the step of oxidizing the silicon layer comprise the step of heating the silicon layer in an oxygen environment.

8. The method of claim 1, wherein the step of positioning the showerhead in a deposition chamber comprises the step of positioning the showerhead in the deposition chamber of a plasma-enhanced chemical vapor deposition apparatus.

9. The method of claim 1, wherein the step of positioning the showerhead in a deposition chamber comprises the step of positioning the showerhead in the deposition chamber of a physical vapor deposition apparatus.

10. The method of claim 1, wherein the step of positioning the showerhead in a deposition chamber comprises the step of positioning the showerhead in the deposition chamber of a chemical vapor deposition apparatus.

11. A method for fabricating a plasma reaction apparatus, the method comprising the steps of:
pre-seasoning a showerhead; and
installing the showerhead into the plasma reaction apparatus.

12. The method of claim 11, wherein the step of pre-seasoning a showerhead comprises the step of forming a protective layer on the showerhead.

13. The method of claim 12, wherein the step of forming a protective layer on the showerhead comprises the step of forming a layer of material on the showerhead wherein the material is selected from the group consisting of silicon oxide (SiO₂), aluminum oxide (Al₂O₃), aluminum nitride (AlN), boron nitrate (BNO₃), aluminum fluoride (AlF), silicon nitride (Si₃N₄), titanium oxide (TiO), boron nitride (BN), boron oxide (B₂O₃), yttrium oxide (Y₂O₃), indium tin oxide (InSnO).

14. The method of claim 12, wherein the step of forming a protective layer on the showerhead comprises the step of forming a protective layer having a substantially uniform thickness in the range of about 0.001 μm to about 50 μm.

15. The method of claim 14, wherein the step of the step of forming a protective layer having a substantially uniform thickness in the range of about 0.001 μm to about 50 μm comprises the step of forming a protective layer having a substantially uniform thickness in the range of about 0.01 μm to about 5 μm.

16. The method of claim 12, wherein the step of forming a protective layer on the showerhead comprises the steps of depositing a silicon layer on the showerhead and oxidizing the silicon layer.

17. The method of claim 11, wherein the step of pre-seasoning a showerhead comprises the step of pre-seasoning the showerhead in a deposition chamber of a plasma-enhanced chemical vapor deposition apparatus.

18. The method of claim 11, wherein the step of pre-seasoning a showerhead comprises the step of pre-seasoning the showerhead in a deposition chamber of a physical vapor deposition apparatus.

19. The method of claim 11, wherein the step of pre-seasoning a showerhead comprises the step of pre-seasoning the showerhead in a deposition chamber of a chemical vapor deposition apparatus.

20. A plasma reaction apparatus comprising:
a container configured for gas flow therethrough and having an inlet end and an outlet end and further configured for ionization of a portion of at least one component of a gas flowing therethrough;
a coil surrounding the container;
an RF generator coupled to the coil;
a processing chamber coupled to the outlet end of the container; and
a pre-seasoned showerhead disposed between the container and the processing chamber.

21. The plasma reaction apparatus of claim 20, wherein the pre-seasoned showerhead has a protective layer disposed thereon and wherein the protective layer comprises a material selected from the group consisting of silicon oxide (SiO₂), aluminum oxide (Al₂O₃), aluminum nitride (AlN), boron nitrate (BNO₃), aluminum fluoride (AlF), silicon nitride (Si₃N₄), titanium oxide (TiO), boron nitride (BN), boron oxide (B₂O₃), yttrium oxide (Y₂O₃), indium tin oxide (InSnO).

22. The plasma reaction apparatus of claim 21, wherein the protective layer has a substantially uniform thickness in the range of about 0.001 μm to about 50 μm.

23. The plasma reaction apparatus of claim 22, wherein the protective layer has a substantially uniform thickness in the range of about 0.01 μm to about 5 μm.
